(19) United States
(12) Patent Application Publication
(10) Pub. No.: US 2023/0032152 A1
(43) Pub. Date: Feb. 2, 2023

(54) TEMPLE MEMBER FOR A SPECTACLE FRAME, AND SPECTACLES INCLUDING SUCH TEMPLE MEMBERS AND SPECTACLE FRAME

(71) Applicant: JULBO, Longchaumois (FR)

(72) Inventor: Adrien Beaud, Longchaumois (FR)

(21) Appl. No.: 17/814,444

(22) Filed: Jul. 22, 2022

(30) Foreign Application Priority Data
Jul. 28, 2021 (FR) 2108184

(51) Int. Cl. G02C 5/22; G02C 5/14

(52) U.S. Cl. CPC G02C 5/229; G02C 5/14; G02C 5/2218

(57) ABSTRACT

A temple intended to be mounted, by a mounting face, in hinged connection, to a spectacle frame, so as to be able to pivot between one and the other of two stable positions called folded position and unfolded position, respectively.

In particular, the temple comprises, from its proximal end toward a distal end, a first section and a second section. The first section is provided with a first face opposite the mounting face). The second section is in a ball joint with the first section. The first face and the second face are also of complementary shapes so as to allow the fitting of one into the other.

### CROSS-REFERENCE TO RELATED APPLICATIONS

Pursuant to 35 U.S.C. § 119(a), this application claims the benefit of the filing date of Australian Patent Application Serial No. FR2108184, filed Jul. 28, 2021, for “TEMPLE OF A SPECTACLE FRAME,” the disclosure of which is hereby incorporated herein in its entirety by this reference.

### TECHNICAL FIELD

The present disclosure relates to the field of spectacle frames. In particular, the present disclosure relates to a temple member for spectacles capable of deforming, or even bending, when a force is exerted thereon.

### BACKGROUND

Conventionally, a pair of spectacles known from the state of the art comprises a frame on which lenses are mounted ensuring a function of protection against the sun and/or a sight correction function and/or a protective function (especially for DIY, in the industrial field or the medical field, etc.). The frame also comprises a front face or main frame (hereinafter “face”) receiving the lenses, and on which temple members are fixed, in hinged connection by way of hinges.

Each hinge makes it possible, in particular, by rotation, to fold (in the closed position) and to unfold (in the open position) the temple member with which the hinge is associated.

In the folded position, the temple members are folded against the face of the spectacle frame so as to reduce their size. In the unfolded position, the temple members are separated from the face and extend along two axes that are substantially parallel to each other and perpendicular to a plane defined by the face of the spectacle frame.

The spectacle frame may be provided with end pieces to limit the relative spacing of the temple members when they are in the unfolded position. However, this configuration gives the spectacle frame a detrimental rigidity when an excessive force is exerted on one and/or the other of the two temple members.

Thus, it has been proposed, for example, in document FR 2,786,883, to implement flexible temple members.

In particular, this document describes a temple of a spectacle frame formed by two parts called the proximal part and the distal part, respectively, connected by a spring-effect element allowing relative movement of the distal part with respect to the proximal part. More particularly, the spring-effect element allows the temple member to bend when a force is exerted on the latter. However, this flexibility of the temple member remains limited to a force in the direction of deployment of the latter.

An object of the present disclosure is therefore to provide an improved spectacle frame temple member compared to the temple member described in document FR 2,786,883. More particularly, an object of the present disclosure is to provide a temple member whose bending is not limited to a single degree of freedom.

### BRIEF SUMMARY

The present disclosure relates to a temple member intended to be mounted by one of its faces, called mounting face, in hinged connection about a hinge axis, to a spectacle frame, so as to be able to pivot between a folded position and an unfolded position, the temple member comprising:
a first section provided with a first housing opening out via the mounting face and via a first face of the first section opposite the mounting face; and
a second section comprising a second face through which a second housing opens out, the first and the second faces being of complementary shapes so as to allow interlocking thereof.

The temple member is also provided with a hinge element fixed to the second section in the second housing and which passes through the first housing to allow one of its ends, called the attachment end, to open out, which end is provided with a knuckle intended to fix the temple member to a tenon of a spectacle frame, the hinge element being configured to exert a return force keeping the first and the second faces interlocked by default, and allowing articulation of the second section with regard to the first section when a force is exerted on the second section.

According to one embodiment, the profile of the first face along a section plane perpendicular to the hinge axis is configured so as to retain the interlocking of the first and the second face when a force is exerted on the second section in a plane perpendicular to the hinge axis in order to fold the temple.

According to one embodiment, the first section comprises an end piece formed by a tongue projecting relative to the first face and in the continuity of an inner face of the first section, the inner face being intended to face a main frame of the spectacle frame when the temple member is folded; the tongue is configured so as to retain the interlocking of the first and the second face when a force is exerted on the temple member in a plane perpendicular to the hinge axis in order to fold it.

According to one embodiment, the profile is W-shaped.

According to one embodiment, the hinge element comprises a rod that extends from the attachment end toward an end, called the terminal end, a spring mounted coaxially on a section of the rod housed in the second housing; the hinge element further comprises, arranged on either side of the spring, and in order from the attachment end toward the terminal end, a threaded bushing and a stop sleeve, the threaded bushing and the stop sleeve being arranged to maintain the spring in compression; the threaded bushing is in sliding connection with the rod and is screwed into the second housing.

According to one embodiment, the stop sleeve is either crimped onto the rod or held in abutment by the spring against an end piece formed on the rod.

According to one embodiment, the threaded bushing is in abutment against a hook formed on the attachment end.

According to one embodiment, the hinge element further comprises an insert of generally planar shape connected to the hook and which comprises a bore forming the knuckle.

The present disclosure also relates to spectacles including a spectacle frame and two temple members according to the present disclosure.

According to one embodiment, each temple member is fixed to a tenon of the frame.

According to one embodiment, the mounting face is flat; each tenon comprises two flat faces called unfolded face and folded face, respectively, the mounting face being intended to bear against the unfolded face when the temple member is unfolded, and resting against the folded face when the temple member is bent.

### BRIEF DESCRIPTION OF THE DRAWINGS

Other features and advantages of the present disclosure will emerge from the following detailed description of a temple member of a spectacle frame with reference to the accompanying figures, in which:

FIG. 1 is a schematic representation, in a perspective view, of a temple member mounted on a spectacle frame according to the present disclosure, the temple member being in an unfolded position;

FIG. 2 is a schematic representation, in a perspective and exploded view, of a temple member and a hinge element that can be implemented in the context of the present disclosure;

FIG. 3 is a partial schematic representation, in perspective view, of a temple member capable of being implemented in the context of the present disclosure; FIG. 3, in particular, shows the attachment end of the hinge element opening out through the mounting face;

FIG. 4 illustrates the effect of a force (represented by an arrow) exerted on the second section in a plane perpendicular to the hinge axis in order to unfold the temple;

FIG. 5 illustrates the effect of a force (represented by an arrow) exerted on the second section in a direction comprised in a plane including the hinge axis and upwards;

FIG. 6 illustrates the effect of a force (represented by an arrow) exerted on the second section in a direction comprised in a plane including the hinge axis and downwards;

FIG. 7 illustrates the effect of a force (represented by an arrow) exerted on the second section along a plane perpendicular to the hinge axis in order to fold the temple, the profile of the first face along a section plane perpendicular to the hinge axis being configured so as to retain the interlocking of the first and second faces when a force is exerted on the second section in a plane perpendicular to the hinge axis in order to bend it;

FIG. 8 is a schematic representation, in perspective view, of a particular hinge element capable of being implemented in the context of the present disclosure;

FIG. 9 is a representation of the hinge element of FIG. 8 in exploded view;

FIG. 10 is a representation, by a side surface, of the system of two cams implemented in the repair/assembly kit;

FIG. 11 is a representation of the two-cam system of FIG. 10, and along a section plane passing through the bores;

FIG. 12 is a representation of the two-cam system by a face from which the bore is formed;

FIG. 13 is a representation of a case of a repair/assembly kit.

### DETAILED DESCRIPTION

The present disclosure relates to a temple member intended to be mounted, by a mounting face, in a hinged connection (also known as a “pivot connection”) about a hinge axis, to a face of a spectacle frame, so as to be able to pivot between one and the other of two stable positions called the folded position and the unfolded position, respectively.

In particular, and according to the present disclosure, the temple member comprises, from its proximal end toward a distal end, a first section and a second section.

The first section is provided with a first face opposite the mounting face.

The second section is in a ball joint with the first section. The first face and the second face are also of complementary shapes so as to allow the fitting of one into the other.

The hinged connection and the ball joint connection are ensured by a hinge element exerting a return force. By default, the latter keeps one of the first and the second face interlocked in the other of the first and the second face, and allows an articulation of the second section with regard to the first section when a force is exerted on the second section.

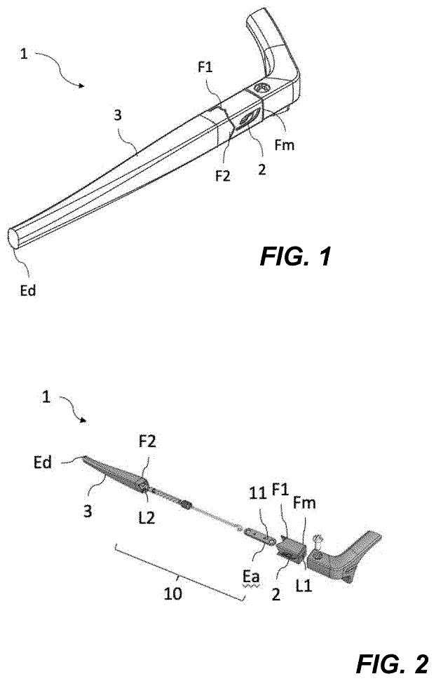

FIG. 1 shows a temple member 1 in accordance with the principles of the present disclosure.

The temple member 1 is intended to be mounted by a mounting face Fm, in hinged connection about a hinge axis, to one face of a spectacle frame. This assembly of the temple member 1 on the spectacle frame, in particular, allows a rotation of the temple member 1 about the hinge axis between one of a folded position and an unfolded position (illustrated in FIG. 1) toward the other of these two positions.

The temple member 1 comprises, from its mounting face Fm toward a distal end Ed, a first section 2 and a second section 3.

In particular, as illustrated in FIG. 2, the first section 2 extends from the mounting face Fm toward the first face F1, and comprises a housing, called the first housing L1, opening out through one and the other of these two faces. In other words, the first housing L1 passes through the first section 2 from the first face toward the mounting face Fm. The first section is advantageously generally parallelepipedal in shape.

The second section 3 comprises a housing, called second housing L2, and which opens out through the second face F2. The second housing L2 may have a longitudinal shape.

Furthermore, and according to the present disclosure, the first face F1 and the second face F2 are of complementary shapes. The complementarity of the shapes specified above allows the interlocking of the first face and the second face. For example, and without, however, limiting the present disclosure to this single aspect, the first face F1 can assume a hollow shape.

The first section 2 and the second section 3 can comprise a plastic material. However, those skilled in the art may, on the basis of their general knowledge, implement any other type of material likely to be suitable.

The temple member 1 is also provided with a hinge element 10 (an example of which is shown in exploded view in FIG. 2).

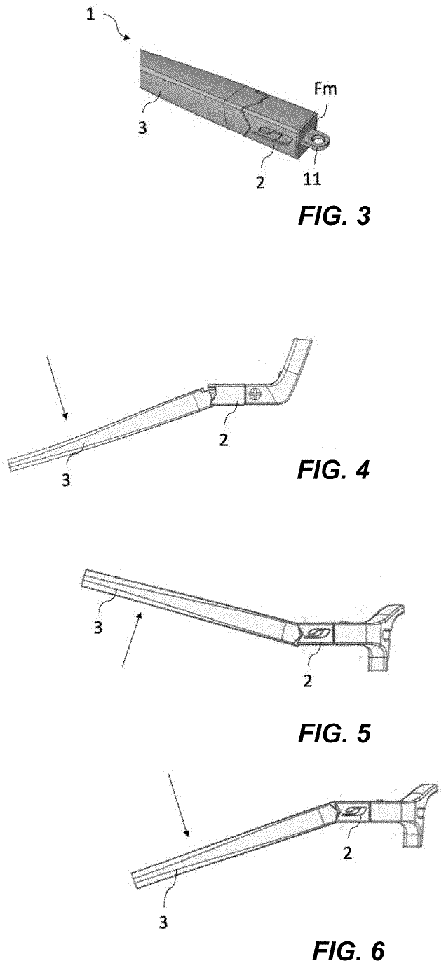

This hinge element 10 is, in particular, fixed to the second section in the second housing L2 and crosses the first housing from the first face F1 toward the mounting face Fm. The hinge element 10 also comprises an end, called the attachment end Ea, provided with a knuckle 11 intended to fix the temple member 1 to a tenon of a spectacle frame. More particularly, the attachment end Ea emerges via the mounting face Fm (FIG. 3).

In other words, when the knuckle 11 is fixed to a knuckle of a tenon of a spectacle frame, the hinge element 10 keeps the first section, the second section and the spectacle frame secured to one another.

Furthermore, the hinge element is configured, when the knuckle 11 is fixed to a knuckle of a tenon of a spectacle frame, to exert a spring effect (or return force) keeping the first and the second face interlocked by default. In addition, the link between the first section and the second section exerted by means of the hinge element is therefore a ball joint. In other words, the hinge element allows rotation of the second section relative to the first section according to the three degrees of freedom of a ball joint when a force is exerted on the second section.

The hinge element 10, according to the principles stated above, can comprise an elastic element, a spring or any other arrangement making it possible to keep the first face and the second face interlocked one inside the other.

FIG. 4, FIG. 5 and FIG. 6 illustrate different articulations depending on a force (whose direction and sense are illustrated by an arrow) exerted on the second section 3.

In particular, in FIG. 4, the force (illustrated by an arrow) is exerted so as to force the deployment of the temple member beyond its unfolded position. Under the effect of this force, the temple member bends at the ball joint. This deflection only involves a movement of the second section.

FIG. 5 illustrates the effect of a force exerted on the second section in a direction comprised in a plane comprising the hinge axis and upwards.

FIG. 6 illustrates the effect of a force exerted on the second section in a direction comprised in a plane comprising the hinge axis and downwards.

In these two examples (FIG. 5 and FIG. 6), a bending of the temple member can also be observed. More particularly, the second section is articulated around the ball joint according to the direction and the sense of the force exerted.

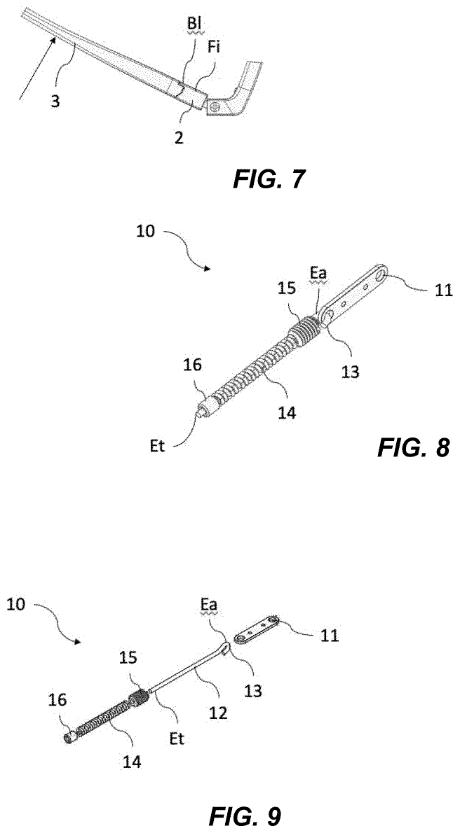

Advantageously, the temple member 1 can be configured to prevent any articulation of the temple member 1 at the ball joint when a force intended to cause the temple member 1 to pivot from its unfolded position to its folded position is exerted on the second section (FIG. 7).

Thus, according to an advantageous embodiment, the profile of the first face along a section plane perpendicular to the hinge axis is configured so as to retain the interlocking of the first and the second face when a force is exerted on the temple member in a plane perpendicular to the hinge axis in order to fold it.

More particularly, the first face may comprise an end piece formed by a tongue B1, in the continuity of an inner face Fi, of the first section, so as to retain the interlocking of the first and the second face when a force is exerted on the temple member in a plane perpendicular to the hinge axis in order to fold it.

The dimensions of the tongue B1 can be determined according to the return force exerted by the hinge element 10.

An inner face of a first section of a temple member is, in particular, the face intended to face the main frame of a pair of spectacles when the temple member carrying the first section is folded. In other words, the inner faces of two first sections of two distinct temple members, called first temple member and second temple, mounted on a spectacle frame, face each other when the first and second temple members are in the unfolded position.

Particularly advantageously, the profile of the first face along a section plane perpendicular to the hinge axis is W-shaped. The bar of the W carried by the inner face of the first section can advantageously form the tongue.

In the rest of the description of the present disclosure, a hinge element 10 of a particular configuration is described. However, the present disclosure should not be limited to this aspect alone.

FIG. 8 schematically shows this hinge element 10, while FIG. 9 shows the latter in exploded view.

The hinge element 10 comprises a rod 12 that extends from the attachment end Ea toward an end called the terminal end Et.

The rod 12 may comprise a metal, and, in particular, may comprise steel, iron, aluminum.

The attachment end Ea of the rod 12 can be formed by a hook 13.

The hinge element 10 can also comprise a spring 14 mounted coaxially on a section of the rod 12 housed in the second housing L2.

This spring 14 can be held in compression by a threaded bushing 15 and a stop sleeve 16. More particularly, the hinge element 10 further comprises, arranged on either side of the spring 14, and in order from the attachment end Ea toward the terminal end Et, the threaded bushing 15, the spring 14 and the stop sleeve 16. It is not strictly necessary to implement the stop sleeve, and any other end pieces can be considered. In particular, crushing, in order to form protuberances, of the rod 12 at the terminal end can serve as abutment for the spring 14.

The threaded bushing 15 and the stop sleeve 16 are arranged to maintain the spring 14 in compression.

The threaded bushing 15 is in sliding connection with the rod 12 and is intended to be screwed into the second housing L2.

The stop sleeve 16 can either be crimped on the rod 12 or held in abutment by the spring 14 against an end piece formed on the rod. The end piece formed on the rod can, in particular, be obtained by pinching the latter.

The threaded bushing 15 can be in abutment against the hook 13 formed on the attachment end Ea.

The hinge element 10 may further comprise the insert of generally planar shape linked to the hook and which comprises a bore forming the knuckle 11. This embodiment of an insert makes it possible to confer better flexibility on the hinge element 10 with regard to the systems known from the state of the art.

Thus, and in operation, this hinge element 10 is fixed to the second section 3 by screwing the threaded bushing 15 into the second housing L2. In other words, the section of the hinge element 10 carrying the threaded bushing 15, the spring 14 and the stop sleeve 16 is housed in the second housing L2.

Another section of this hinge element 10 passes through the first section 2 so that the knuckle of the element opens out via the mounting face Fm. The knuckle is in turn fixed to the knuckle of a tenon of a spectacle frame.

The spring 14 is held in compression so as to exert a return force between the second section 3 and the knuckle of the tenon of the spectacle frame. The first section 2 is therefore interposed between the second section and the knuckle of the tenon of the spectacle frame.

A force exerted on the second section 3 therefore forces the threaded bushing to slide along the rod and in the direction of the stop sleeve 16. This movement imposes an additional compression of the spring 14.

The present disclosure also relates to a spectacle frame comprising two temple members according to the present disclosure.

Each temple member can be fixed to a tenon of the frame.

Advantageously, the mounting face Fm is flat, and each tenon comprises two flat faces called unfolded face and folded face, respectively, the mounting face being intended to bear against the unfolded face when the temple member is unfolded, and resting against the folded face when the temple member is bent.

This last aspect makes it possible to confer a stable nature on the folded position and the unfolded position of a temple. Indeed, the ridge formed between the folded face and the unfolded face induces instability in the pivoting of the temple member from one of the folded position and the unfolded position to the other of these two positions. More particularly, if the force leading to the pivoting of the temple member is released before this instability is reached, the temple member will return to its initial position. In contrast, if the force leading to the pivoting of the temple member is released after having reached this instability, the temple member will complete its course and tilt into the target position.

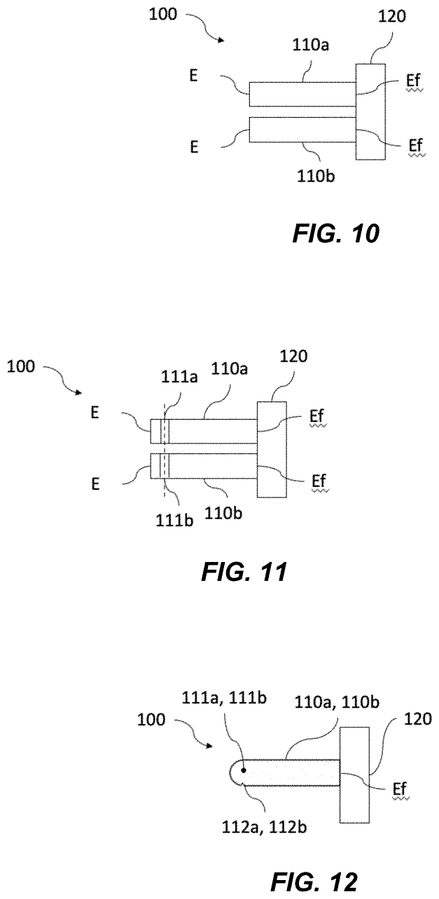

The present disclosure also relates to a kit for repairing/assembling the hinge element (FIG. 10, FIG. 11, and FIG. 12). The kit in this regard comprises a hinge element 10. In particular, the hinge element of the repair kit uses the terms of the hinge element described in relation to FIGS. 8 and 9.

The kit also comprises a pin, a screw, as well as a tensioning element. The tensioning element 100 comprises a system with two cams 110a and 110b, essentially identical, and fixed to a support 120 by one of their ends, called the fixing end Ef. The end E of each of the cams 110a and 110b, opposite their fixing end Ef, is rounded and includes a bore 111a and 111b arranged on the diameter of the rounded end. In particular, each of the bores 111a and 111b is eccentric with respect to the center of the rounded end so as to ensure the cam effect. Each cam 110a and 110b comprises a notch 112a, 112b formed on the side flank of the cams. The two cams 110a and 110b, fixed on the support 120, are parallel to each other and arranged so that the two bores 111a and 111b are continuous with each other (in other words, the two axes of revolution of the two bores coincide). Furthermore, the two cams 110a and 110b are spaced apart so as to allow the passage of the insert.

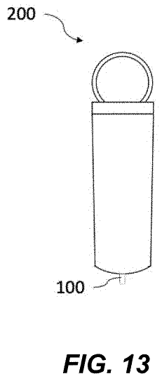

The repair/assembly kit can comprise a case 200, one wall of which forms the support 120, and intended to store the screw, the pin(s) and the hinge element (FIG. 13).

The present disclosure is of course not limited to the embodiments described, and it is possible to provide variant embodiments without departing from the scope of the invention as defined by the claims.

What is claimed is:

1. A temple member for spectacles, the temple member configured to be mounted by a mounting face thereof, in hinged connection about a hinge axis, to a spectacle frame of the spectacles, such that the temple member is capable of pivoting between a folded position and an unfolded position relative to the spectacle frame, the temple member comprising:
a first section including a first housing opening out via the mounting face and via a first face of the first section opposite the mounting face;
a second section having a second face through which a second housing opens out, the first face and the second face having complementary shapes so as to allow interlocking thereof; and
a hinge element fixed to the second section in the second housing, the hinge element passing through the first housing to allow an attachment end of the hinge element to open out, the attachment end having a knuckle configured to fix the temple member to a tenon of the spectacle frame, the hinge element configured to exert a return force keeping the first face and the second face interlocked by default, and to allow articulation of the second section relative to the first section when a force is exerted on the second section.

2. The temple member of claim 1, wherein a profile of the first face along a section plane perpendicular to the hinge axis is configured so as to retain the interlocking of the first face and the second face when a force is exerted on the second section in a plane perpendicular to the hinge axis to fold the temple member.

3. The temple member of claim 2, wherein the profile of the first face is W-shaped.

4. The temple member of claim 2, wherein the first section comprises an end piece having a tongue projecting relative to the first face and in a continuity of an inner face of the first section, the inner face being configured to face a main frame of the spectacle frame when the temple member is folded, the tongue being configured to retain the interlocking of the first face and the second face when a force is exerted on the temple member in a plane perpendicular to the hinge axis to fold the temple member.

5. The temple member of claim 3, wherein the profile of the first face is W-shaped.

6. The temple member of claim 4, wherein the hinge element comprises a rod extending from the attachment end toward a terminal end, a spring mounted coaxially on a section of the rod housed in the second housing, the hinge element comprising, arranged on either side of the spring, in order from the attachment end toward the terminal end, a threaded bushing and a stop sleeve of the spring, the threaded bushing and the stop sleeve being arranged to maintain the spring in compression, the threaded bushing being in sliding connection with the rod and screwed into the second housing.

7. The temple member of claim 1, wherein the hinge element comprises a rod extending from the attachment end toward a terminal end, a spring mounted coaxially on a section of the rod housed in the second housing, the hinge element comprising, arranged on either side of the spring, in order from the attachment end toward the terminal end, a threaded bushing and a stop sleeve of the spring, the threaded bushing and the stop sleeve being arranged to maintain the spring in compression, the threaded bushing being in sliding connection with the rod and screwed into the second housing.

8. The temple member of claim 7, wherein the stop sleeve is either crimped onto the rod or held in abutment by the spring against an end piece formed on the rod.

9. The temple member of claim 7, wherein the threaded bushing is in abutment against a hook formed on the attachment end.

10. Temple according to claim 9, wherein the hinge element further comprises an insert of generally planar shape connected to the hook and which comprises a bore forming the knuckle.

11. Spectacles, comprising:
a spectacle frame; and
two temple members, each temple member being configured to be mounted by a mounting face thereof, in hinged connection about a hinge axis, to the spectacle frame, such that each temple member is capable of pivoting between a folded position and an unfolded position relative to the spectacle frame, each temple member comprising:
a first section including a first housing opening out via the mounting face and via a first face of the first section opposite the mounting face;
a second section having a second face through which a second housing opens out, the first face and the second face having complementary shapes so as to allow interlocking thereof; and
a hinge element fixed to the second section in the second housing, the hinge element passing through the first housing to allow an attachment end of the hinge element to open out, the attachment end having a knuckle configured to fix the temple member to a tenon of the spectacle frame, the hinge element configured to exert a return force keeping the first face and the second face interlocked by default, and to allow articulation of the second section relative to the first section when a force is exerted on the second section.

12. The spectacles of claim 11, wherein each temple member is fixed to a respective tenon of the spectacle frame.

13. The spectacles of claim 12, wherein the mounting face is flat, each tenon comprises a flat unfolded face and a flat folded face, respectively, the mounting face configured to bear against the unfolded face when the temple member is unfolded, and to rest against the folded face when the temple member is folded.
